(19) United States
(12) Patent Application Publication
(10) Pub. No.: US 2012/0148440 A1
(43) Pub. Date: Jun. 14, 2012

(54) COPPER BRAZING FILLER METAL

(75) Inventors: Kazuhiko ITOH, Seto-shi (JP); Tadashi OSHIMA, Aichi-gun (JP); Hisaaki TAKAO, Seto-shi (JP)

(73) Assignee: KABUSHIKI KAISHA TOYOTA CHUO KENKYUSHO, Aichi-ken (JP)

(21) Appl. No.: 13/310,160

(22) Filed: Dec. 2, 2011

(30) Foreign Application Priority Data
Dec. 8, 2010 (JP) 2010-273351

(51) Int. Cl. B23K 35/22; C22C 9/05; B23K 35/30; C22C 9/06

(52) U.S. Cl. 420/487; 420/587; 420/582

(57) ABSTRACT

A copper brazing filler metal includes Ni in an amount of from 20 or more to 36% or less by mass, Mn in an amount from 19 or more to 30% or less by mass, Fe in an amount of from 0 or more to 16% or less by mass, Si in an amount of from more than 0 (not inclusive) to 2% or less by mass, B in an amount of from 0.1 or more to 0.5% or less by mass, and the balance being copper (Cu) as well as inevitable impurities and/or a modifying element, when the entirety is taken as 100% by mass. Moreover, the copper brazing filler metal exhibits a ratio of the Ni content with respect to the Mn content (i.e., (Ni Content)/(Mn Content)) that falls in a range of from 1.1 or more to 2 or less when being free from Fe.

### INCORPORATION BY REFERENCE

The present invention is based on Japanese Patent Application No. 2010-273,351 filed on Dec. 8, 2010, the entire contents of which are incorporated herein by reference.

### BACKGROUND OF THE INVENTION

1. Field of the Invention

The present invention relates to brazing for uniting members comprising ferrous materials with each other. In particular, it relates to brazing for uniting members at least one of which comprises a ferrous sintered body with each other.

2. Description of the Related Art

It has been often the case that ferrous sintered component parts are manufactured as follows: a raw-material powder including iron is prepared by compounding or mixing raw materials in order to make a given elemental composition; the resultant raw-material powder is formed as a predetermined shape or configuration with a die; and then the resultant green compact is sintered. However, sintered component parts having complicated shapes that are difficult to form with a die have been usually made by the following processes: many component-part elements are formed in advance as sections that have divided complex shapes; the resultant preforms or green compacts for component-part elements are combined to unite them by brazing at the joint faces between them that come in contact with each other after sintering the preforms or green compacts; or the resultant preforms or green compacts are united with each other by brazing at the time of sintering them. Yet, since many pores exist in green compacts and sintered bodies, the “infiltration phenomena” occur in which fused or molten brazing metals infiltrate into the pores through the joint faces between the green compacts or sintered bodies because of the capillary action. As a result, the pores might hinder carrying out brazing satisfactorily. Therefore, brazing metals that are suitable for such brazing operations have been heretofore proposed so far.

For example, U.S. Pat. No. 4,029,476 discloses a brazing alloy compositions comprising nickel alloys that include copper, manganese, iron, silicon and boron. Meanwhile, Japanese Unexamined Patent Publication (KOKAI) Gazette No. 5-186,810 and Japanese Unexamined Patent Publication (KOKAI) Gazette No. 2-15,875 disclose brazing filler metals comprising copper alloys that include nickel, manganese, iron, silicon and boron, respectively.

U.S. Pat. No. 4,029,476, Japanese Unexamined Patent Publication (KOKAI) Gazette No. 5-186,810, and Japanese Unexamined Patent Publication (KOKAI) Gazette No. 2-15,875 disclose brazing filler metals as examples that contain boron in greater contents. Especially, the brazing filler metals include boron in a content of more or less 1% by mass approximately even when they contain it less. The conventional brazing filler metals have compositions in which boron is included in greater amounts, because boron oxides that generate at the time of brazing operations make the wettability of the conventional brazing filler metals favorable with respect to the joint faces of members to be united together. However, it has been found out that boron reacts with iron at temperatures adjacent to sinter g temperatures to form brittle metallic structures such as Fe₂B. The brittle metallic structures that have been formed at joint sections between members to be united together or in the vicinity thereof might result in declining strengths at the joint sections.

Moreover, green compacts and sintered bodies are not uniform or homogenous as a whole, strictly speaking. That is, even when they make one and only green compact and sintered body respectively, they fluctuate in the density, pore size and surface roughness depending on their respective parts. For example, in green compacts and sintered bodies, faulty joining resulting from the lack of sufficient brazing filler metals is likely to occur, because the fused or molten brazing filler metals are likely to infiltrate into green compacts or sintered bodies when the green compacts or sintered bodies are of lower density. Even when green compacts or sintered bodies to be joined together have an equal density one another, the likeliness of infiltrating fused or molten brazing filler metals depends greatly on the differences between the green compacts' or sintered bodies' pore sizes or surface roughness. Accordingly, in joined bodies that are obtained by brazing green compacts and/or sintered bodies together, the joint strengths would fluctuate depending on the joint faces' locations. Consequently, it might be even difficult to maintain a constant joint strength at one joint as a whole. As a result, when joined bodies are mass-produced by brazing green compacts with an identical density together, or sintered bodies with an identical density together, under predetermined conditions, the resulting joined bodies might fluctuate in the joint strengths so greatly that it might be difficult to secure qualities for each of the joined bodies.

### SUMMARY OF THE INVENTION

Hence, it is an object of the present invention to provide a brazing filler metal that can keep exhibiting a higher joint strength even between green compacts and/or sintered bodies whose joint faces fluctuate in the properties.

It is possible to inhibit brittle metallic structures such as Fe₂B from generating by minimizing the mixing or compounding amounts of boron and silicon, which is liable, like boron, to react with the other elements to turn into brittle metallic structures. However, boron is an element that makes the wettability of brazing filler metals to joint faces favorable due to the effects of boron oxides that generate during brazing operations. Moreover, silicon is an element that improves the flowability and wettability of brazing filler metals. Accordingly, reducing the contents of boron and silicon might possibly lead to adversely declining the joint strength between workpieces or members to be united together. Consequently, the present inventors tried to control the overall compositions of brazing filler metals within an optimum range as a whole, and found out a copper brazing filler metal that can keep exhibiting a joint strength satisfactorily even when the contents of boron and silicon are less.

A copper brazing filler metal according to the present invention is a brazing filler metal for joining sintered component parts having a joint between at least two joined workpieces being made of a ferrous material, at least one of the two joined workpieces comprising a sintered body,

the copper brazing filler metal comprises:

nickel (Ni) in an amount of from 20 or more to 36% or less by mass (hereinafter being simply referred to as “%”);

manganese (Mn) in an amount from 19 or more to 30% or less;

iron (Fe) in an amount of from 0 or more to 16% or less;

silicon (Si) in an amount of from more than 0 (not inclusive) to 2% or less;

boron (B) in an amount of from 0.1 or more to 0.5% or less; and

the balance being copper (Cu) as well as inevitable impurities and/or a modifying element;

when the entirety is taken as 100%; and

the copper brazing filler metal exhibits a ratio of the Ni content with respect to the Mn content (i.e., (Ni Content)/(Mn Content)) that falls in a range of from 1.1 or more to 2 or less when being free from Fe.

A copper brazing filler metal according to the present invention comprises B and further Si in reduced amounts, compared with those in conventional brazing filler metals. It is believed that the resulting joint is of high strength because the reduced B content results in inhibiting brittle metallic structures from forming upon brazing, and because brittle metallic structures not only arise in a reduced amount but also disperse micro-finely even if they should occur. On the other hand, it is assumed that the reduced B content might lead to declining the wettability of brazing filler metal with respect to joint faces. However, controlling the mixing or compounding proportions of the other alloying elements within appropriate ranges makes it possible to keep adequate wettability, which enables the resultant brazing filler metals to wet joint faces entirely, while inhibiting the brazing filler metals from infiltrating excessively. As a result, the present copper brazing filler metal enables manufactures not only to inhibit the strength at the joint from fluctuating but also to maintain it highly, even when they employ the present copper brazing filler metal to carry out brazing onto green compacts or sintered bodies that are poor in terms of uniformness in their surface properties.

Using the above-described copper brazing filler metal according to the present invention enables manufactures to carry out brazing highly reliably onto green compacts and sintered bodies that are likely to exhibit qualities inhomogenously or nonuniformly. As a result, the present copper brazing filler metal also enables manufactures to make the supply amount of brazing filler metal for brazing operations less than they have been heretofore supplying brazing filler metals conventionally.

Note that the copper brazing filler metal according to the present invention involves both Cu—Ni—Mn—Si—B brazing filler metals, which are free from Fe, and Cu—Ni—Mn—Fe—Si—B brazing filler metals, which include Fe. However, meeting the above-described composition as a whole upon being served for brazing operations can make the present copper brazing filler metal. To put it differently, as being detailed later, it is needless to say that, even when is Fe added in a powdered form at the time of brazing operations, the present copper brazing filler metal can involve the resulting overall compositions that fall in the compositional range according to the present copper brazing filler metal on the occasion of Fe addition.

The copper brazing filler metal according to the present invention enables manufacturers to manufacture joined bodies that exhibit higher strength at the joint than when they make the joined bodies employing conventional brazing filler metals. Moreover, the present copper brazing filler metal having the composition that falls in a certain more desirable range enables manufacturers to carry out joining operations highly reliably, because it can inhibit the resultant joined bodies from fluctuating in strength at the joint.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a schematic diagram for illustrating an example of brazing methods.

FIG. 2 is a schematic diagram for illustrating a method of measuring strength upon fracture or breakage.

FIG. 3 is a graph for showing fracture or breakage strengths being exhibited by joined bodies that were made by brazing with use of various copper brazing filler metals, graph in which the fracture or breakage strengths are plotted in relation to the contents of boron and silicon that the copper brazing filler metals contained.

FIG. 4 is a photograph for showing results of an observation on a cross section at the joint in a joined body that was made by brazing with use of a copper brazing filler metal according to the present invention, photograph which substitutes for the diagram.

FIG. 5 is a photograph for showing results of an observation on a cross section at the joint in a joined body that was made by brazing with use of another copper brazing filler metal according to the present, photograph which substitutes for the diagram.

FIG. 6 is a photograph for showing results of an observation on a cross section at the joint in a joined body that was made by brazing with use of a conventional copper brazing filler metal, photograph which substitutes for the diagram.

FIG. 7 is a detailed photograph for showing parts in a joint's cross section at which an elemental analysis was carried out with use of an electron-beam prove microanalyzer (or EPMA), photograph which substitutes for the diagram.

FIG. 8 is a photograph for showing results of an observation on a cross section at the joint in a joined body that was made by brazing with use of a copper brazing filler metal according to the present that was processed as a thin sheet shape, photograph which substitutes for the diagram.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Hereinafter, the present invention will be described in more detail while naming specific embodiments that are directed to the copper brazing filler metal according to the present invention. Note that it is possible to combine any of numeric values being set forth in the present specification to make any new specific ranges of the combined numeric values. Moreover, unless otherwise specified, ranges of numeric values, namely, “from ‘x’ to ‘y’” being referred to in the present specification, involve the lower limit, “x,” and the upper limit, “y,” in the ranges that they represent.

The copper brazing filler metal according to the present invention is used for manufacturing joined body. For example, the joined body has a joint between two joined workpieces that are made of a ferrous material, and at least one of which comprises a sintered body. Although the joint comprises a ferrous material, the type of a ferrous material making the joint is not limited especially. That is, the ferrous material can comprise iron, or an iron alloy whose major component is iron, such as carbon steels and alloy steels, for instance. Note that only a superficial layer, which includes the joint face at least, can be made of a ferrous material, whereas the other portions or sections are not limited especially in terms of materials for making them. The present copper brazing filler metal is used in the manufacture of joined body in which a sintered body makes at least one of the two joined workpieces. For example, a joined body, which is made using the present copper brazing filler metal, can comprise a sintered body partially at least. When two workpieces to be joined together are specified as a “first member (or component part),” and a “second member (or component part),” respectively, the two members to be joined together with use of the present copper brazing filler metal can have the following forms, for instance, prior to the joining: the first member can partially comprise a green compact and/or a sintered body at least at one of the parts to be united; whereas the second member can partially comprise any one of cast products being made by various casting processes, melt-produced stocks, green compacts and sintered bodies at least at one of the parts to be united. Note that, when carrying out a joining operation onto a green compact, it is preferable to carry out sintering the green compact simultaneously with the brazing operation. Although the present copper brazing filler metal is effective in joining green compacts and sintered bodies that have a wide variety of densities, it is preferable that the green compacts and sintered bodies can exhibit a density ratio (ρ/ρ₀×100(%)), a ratio of a green compact's or sintered body's density ρ with respect to a cast product's density ρ₀, that is 80% or more, or more preferably, that is 85% or more.

The copper brazing filler metal according to the present invention comprises Ni in an amount of from 20 or more to 36% or less, Mn in an amount from 19 or more to 30% or less, Fe in an amount of from 0 or more to 16% or less, Si in an amount of from more than 0 (not inclusive) to 2% or less, B in an amount of from 0.1% or more to 0.5% or less, and the balance being Cu as well as inevitable impurities and/or a modifying element, when the entirety is taken as 100%.

B is an element that enhances the wettability of brazing filler metal, because it forms oxides that serve as a flux generally in brazing filler metals. However, B forms brittle intermetallic compounds, such as Fe₂B, at the time of brazing operations, and the resulting brittle intermetallic compounds lead to declining joint strength. To keep adding B down to in an amount of 0.5% or less makes it possible to maintain the strength of joining highly, not only because the brittle intermetallic compounds crystallize in a reduced amount but also because they disperse micro-finely even when they should have crystallized. It is preferable that the upper limit of the B content can be less than 0.5% (not inclusive), or more preferably, can be 0.45% or less. The B content being too small might make joining operations themselves difficult. However, as far as the B content is at around 0.1% or more, it is possible to highly maintain the wettability and eventually the strength of joining by controlling the content proportions of the other constituent elements. Moreover, it is preferable that the lower limit of the B content can be 0.2% or more. In addition, it is more preferable that the lower limit of the B content can be 0.3% or more in order to upgrade the strength of joining furthermore.

Si is an element that improves the flowability and wettability of brazing filler metal. Moreover, adding Si along with B compositely improves the strength of joining greatly. Accordingly, the copper brazing filler metal according to the present invention can comprise Si in a small amount more or less (e.g., more than 0% (not inclusive)). It is preferable that the present copper brazing filler metal can comprise Si in an amount of 0.1% or more, or more preferably, in an amount of 0.5% or more. However, since containing Si in an amount of more than 2.0% (not inclusive) results in declining the strength of joining or in fluctuating qualities greatly, it is preferable that the upper limit of the Si content can be 2.0% or less, or more preferably, can be 1.8% or less, or much more preferably, can be 1.6% or less.

Since both B and Si produce the effect of lowering the melting point of brazing filler metal, they are used to control the melting point of the copper brazing filler metal according to the present invention. On the other hand, however, B and Si are likely to form brittle inter metallic compounds, brittle eutectic structures, and so on. Accordingly, in the case of the present copper brazing filler metal that is free from Fe especially, it is preferable to keep the upper limit of a summed content of the B and Si contents (i.e., (B Content)+(Si Content)) down to 2.3% or less, or more preferably, down to 2.25% or less.

In the copper brazing filler metal according to the present invention, not only the Ni and Mn contents but also the Fe content, if needed, are controlled within adequate ranges in order to compensate the effects being produced less by B and moreover Si whose mixing or compounding amounts are reduced. For example, it is preferable that the Ni content can fall in a range of from 20 or more to 36% or less, or more preferably, in a range of from 20 or more to 35% or less, or much more preferably, in a range of from 23 or more to 32% or less. Moreover, it is preferable that the Mn content can fall in a range of from 19 or more to 30% or less, or more preferably, in a range of from 20 or more to 28% or less, or much more preferably, in a range of from 20 or more to 27% or less. In addition, it is preferable that the Fe content can be 0% (i.e., being free from Fe); alternatively, it is preferable that the Fe content can fall in a range of from more than 0 (not inclusive) to 16% or less, or more preferably, in a range of more than 0 (not inclusive) to 15% or less, or much more preferably, in a range of from 2 or more to 13% or less. Ni, Mn and Fe are elements that contribute to upgrading strengths. However, it is preferable that the upper limit of the Ni content can be set at 36% or less, because it is expensive. Moreover, it is preferable that the upper limit of the Mn content can be set at 30% or less, because the resultant toughness might decline when it is mixed or compounded excessively. Note that Fe can be added in an amount of 2% or more in order to reduce fluctuations in the strength of joining that result from inhomogenety or nonuniformity of joint face. However, excessive Fe contents cause the molten separation of brazing filler metal, because phase-separation regions expand. Accordingly, the Fe addition can be kept down to 16% or less. Note that Fe is not an indispensable element for the present copper brazing filler metal. However, the addition of Fe produces an advantage of intending to remarkably reduce the raw-material cost of the present copper brazing filler metal, because the addition makes it possible to employ inexpensive ferroboron as a raw material for B.

Ni, Mn and Fe are elements that contribute to upgrading strengths. However, mixing or compounding Mn excessively might lead to declining the resultant toughness, as described above. Therefore, it is possible to make an index for the strength of joining by determining or defining the Mn content with use of a ratio between a summed content of the Ni and Fe contents and the Mn content, for instance, {(Ni Content)+(Fe Content)}/(Mn Content). Moreover, the index can be expressed as (Ni Content)/(Mn Content) when the copper brazing filler metal according to the present invention is free from Fe. Note that the index, (Ni Content)/(Mn Content), can be controlled so as to fall in a range of from 1.1 or more to 2 or less when the present copper brazing filler metal comprises a Cu—Ni—Mn—Si—B brazing alloy that is free from Fe. Moreover, when the present copper brazing filler metal comprises a Cu—Ni—Mn—Si—B—Fe brazing alloy that includes Fe, the index, (Ni Content)+(Fe Content)/(Mn Content), can be preferably controlled so as to fall in a range of from 1.1 or more to 2.5 or less. Note that a more preferable value of the upper limit can be 2.4 or less, 2.1 or less, or 2 or less. In either case, it is more preferable that {(Ni Content)+(Fe Content)}/(Mn Content), or (Ni Content)/(Mn Content), can fall in a range of from 1.1 or more to 1.9 or less, more preferably, in a range of from 1.15 or more to 1.85 or less.

Note that the compositions of the inevitable impurities and modifying element are, as a matter of course, not limited especially. The “inevitable impurities” are not only impurities that are included in raw-material powders, but also they are impurities that are mixed accidentally during the production steps. That is, the “inevitable impurities” are elements that are difficult to remove in view of costs, or due to technical reasons. The “modifying element” is an element other than Cu, Ni, Mn, Fe, Si and B, and is an element that is effective for improving the characteristics of brazing filler metal when being included in a trace amount. Moreover, types of the “characteristics of brazing filler metal” to be improved do not matter at all, although whatever the characteristics the present specification refers to.

The copper brazing filler metal according to the present invention is not limited in terms of its shape. For example, the following can be employed: ingots or powders comprising the alloy that has the above-described composition; and green compact exhibiting the above-described composition as a whole.

When melt producing the copper brazing filler metal according to the present invention, ingots comprising the above-described copper alloys can be made with use of a common dissolving process, such as high-frequency dissolving methods, for instance. Moreover, when turning the present copper brazing filler metal into powders, the resulting ingots can be pulverized in order to turn them into powders. Alternatively, molten alloys can be turned into powders with use of an atomizing process.

Moreover, the above-described ingots being made by a fusing or melting process can be processed into desirable shapes (such as thin plates, thin sheets or wire stocks) that make it possible to supply the resulting brazing filler metals so that they fit into or conform to the dimensions or shapes of joint faces at the time of brazing operations. In addition, the copper brazing filler metal according the present invention comprises B in an amount that is reduced less than conventional copper brazing filler metals do, thereby inhibiting brittle compounds from generating. As a result, it is possible to subject the ingots resulting from the present copper brazing filler metal to various processes. Specifically, the ingots can be subjected to a variety of plastic working processes, such as hot forging, hot rolling, cold rolling, hot swaging, cold swaging, wire drawing with die, drawing and extrusion. When the ingots undergo hot working, it is preferable to carry out the hot working at a temperature of from 750 to 900° C. When the ingots undergo cold working or warm working, it is preferable to carry out the cold working or warm working at room temperature, more preferably, at a temperature of from 25 to 750° C. From the viewpoint of enhancing the resulting products' qualities, such as the dimensional accuracy, it is desirable to further carry out cold working, if needed, after hot working and then annealing the ingots. Note that it is assumed that the “thin plate or sheet” herein implies to have a thickness of from 0.05 to 1 mm approximately, and that the “rod stock” herein implies to have a wire diameter of from φ 0.5 to 10 mm approximately. However, the thickness, and wire diameter are not limited to these ranges, because they depend on specific joined bodies. In addition, the resulting thin sheets or wire stocks can be cut to any dimensions in order to use.

However, the copper brazing filler metal according to the present invention might make brittle ingots relatively depending on the composition. Accordingly, depending on dimensions or shapes, it might be difficult to process the present copper brazing filler metal into thin plates or sheets, or wire stocks. Consequently, when it is difficult to process the present copper brazing filler metal by the above-described processes, a process being described below can be employed in order to make thin sheet-shaped or wire-shaped copper brazing filler metals having dimensions or configurations that enable brazing workers or robots to supply the resulting brazing filler metals so as to fit into or conform to the dimensions or shapes of joint faces at the time of brazing operations.

First of all, a mixed powder is prepared at a mixed-powder preparation step. That is, an Ni—Mn—Si—B alloy powder comprising an alloy that includes Ni, Mn, Si and B at least, and a copper powder including copper at least are mixed in proportions that are in compliance with a targeted composition. Then, the resultant mixed powder is subjected to pressure forming at a forming step, thereby obtaining a green compact. At the forming step, the mixed powder can even be formed as a sheet shape by means of powder rolling process. The resulting green compact can be provided for brazing operations as it is. Alternatively, the resultant green compact can be subjected to sintering, and then the resulting alloyed brazing filler metal can be provided for brazing operations. However, it is preferable to carryout extra shaping onto the green compact additionally in order to give it a shape that is more likely to be employed or dealt with.

The green compact being produced at the forming step can be calcined preliminarily, if needed, and can thereafter processed into a predetermined shape at a secondary forming step. The preliminary calcination can be carried out by heating the green compact at a temperature of from 700 to 850° C. for a time period of from 20 to 90 minutes, for instance. Moreover, in view of preventing the constituent elements, such as Mn and Fe, from being oxidized, it is preferable to carry out the preliminary calcination in an inert atmosphere. At the secondary forming step, the green compact being subjected to the preliminary calcination is formed furthermore by means of plastic working, for instance. Specifically, the following can be named: turning the green compact into thin sheets by means of cold rolling; and turning it into rod stocks by means of rolling or swaging. Note that it is assumed that the “thin plate or sheet” being described herein implies to have a thickness of from 0.05 to 1 mm approximately, and that the “rod stock” implies to have a wire diameter of from φ 0.5 to 10 mm approximately. However, the thickness and wire diameter are not limited to these ranges, because they depend on specific joined bodies. The resulting thin sheets or wire stocks can be cut to any dimensions. The green compact having undergone the secondary forming step can be provided for brazing operations as it is. Alternatively, the green compact having undergone the secondary forming step can even be calcined fully or completely at a temperature that is lower than a melting point of the green compact being subjected to the secondary forming step. The full or complete calcination can be carried out by heating the green compact having undergone the secondary forming step at a temperature of from 700 to 900° C. for a time period of from 10 to 90 minutes, for instance. In order to prevent the constituent elements, such as Mn and Fe, from being oxidized, it is likewise preferable to do the full or complete calcination in an inert atmosphere.

The Ni—Mn—Si—B alloy powder to be employed at the above-described mixed-powder preparation step can even include Fe in the alloy composition. Alternatively, an iron powder including Fe at least can also be mixed or compounded along with the Ni—Mn—Si—B alloy powder and the copper powder. These powders are not limited especially in terms of their particle diameters. However, it is desirable to classify them so as to have a particle diameter of 200 μm or less, or more desirably, a particle diameter of 150 μm or less, for instance, before employing them actually at the mixed-powder preparation step.

In the above-described process, the ductility that copper exhibits intrinsically is utilized in order to carry out the plastic working satisfactorily. Accordingly, it might be difficult to carry out the plastic working reliably when the mixed powder does not include any copper powder in a certain extent of amount. For example, it is desirable that the mixed powder can include the copper powder in an amount of from 30% or more, or more desirably, in an amount of from 40 to 60%, when the entire mixed powder is taken as 100%. Note, however, that it might be difficult to apply the manufacturing process as described above to the resulting brazing filler metal when it includes Fe in a greater amount. Consequently, Fe can preferably be added to the resultant brazing filler metal separately or independently as described below.

The copper brazing filler metal according to the present invention enables brazing workers or robots to carry out brazing operations by the same method as they have been doing heretofore with conventional brazing filler metals. That is, the present copper brazing filler metal can even be fused or melted under such a condition that it is held between two joint faces. Alternatively, it is also possible to fuse or melt the present copper brazing filler metal under such a condition that it is put in place adjacent to two joint faces, and then to let the resultant molten brazing filler metal intrude of itself along the two joint faces. Moreover, since the present copper brazing filler metal having the above-described composition exhibits a melting point of from 970 to 1,100° C. approximately, a copper-brazed layer can be formed between two joint faces by raising the present copper brazing filler metal's temperature up to the fusing or melting temperature before solidifying the preset copper brazing filler metal upon carrying out brazing operations. On this occasion, the rate of temperature increment is not limited especially. However, it is desirable to control the temperature-increment rate so as to fall in a range of from 5 to 100° C./minute, because the faster it is the more nonuniform or inhomogenous it becomes so that the resulting joint strengths have fluctuated greatly. In addition, from the viewpoint of preventing the constituent elements, such as Mn and Fe, from being oxidized, it is preferable to carry out brazing operations in an inert atmosphere, in particular, in a nitrogen gas atmosphere.

The copper brazing filler metal according to the present invention can keep exhibiting a strength of joining even when it is supplied in a small amount of 0.5 g/cm² or less. The present brazing filler metal can also be supplied in a smaller amount of 0.35 g/cm² or less, or even in a much smaller amount of 0.25 g/cm² or less. A desirable supply amount of the present brazing filler metal can be set up daringly so as to fall in a range of from 0.1 g/cm² or more to 0.4 g/cm² or less. The term, “supply amount,” means a mass of the present copper brazing filler metal that is supplied to a unit area of face into which the present copper brazing filler metal goes in. Note that the term, “face,” involves one of two joint faces, which are placed oppositely to each other at the time of joining. If, in addition to those two joint faces, the other faces exist into which the present capper brazing filler metal goes in, the term, “face,” also involves the other faces.

Moreover, since the sintering temperatures of green compacts comprising ferrous materials overlap the fusing or melting temperature of the copper brazing filler metal according to the present invention, it is even feasible to braze and sinter the green compacts at the same time. It such is the case, it is desirable that a heating temperature can fall in a range of from 1,000 to 1,200° C., or more desirably, in a range of from 1,100 to 1,200° C.

In addition, Fe can be added to the copper brazing filler metal according to the present invention upon carrying out brazing operations. For example, an Fe-free copper brazing filler metal with the above-described composition that does not include any Fe can be made ready for brazing operations in advance, and then a predetermined amount of ferrous source can be put in place in the proximity of the joint faces adjacent to the Fe-free copper brazing filler metal upon carrying out the brazing operations. In this instance, when a sum of the mixture of the Fe-free copper brazing filler metal and ferrous source is taken as 100%, the mixture can comprise the constituent elements as well as Fe in amounts that fall within the above-described compositional ranges that are directed to the present copper brazing filler metal. The ferrous source can be put in a state of iron powders or foils.

Moreover, it is not necessarily impossible to think of that no favorable joints might be obtained because the resulting present copper brazing filler metal might be inferior to the other brazing filler metals in the wettability, depending on the joints' material qualities. If such is the case, fluxes can even be employed similarly in order to improve the wettability in the same fashion as having been done heretofore in conventional brazing processes.

As described above, some of the embodiment modes of the copper brazing filler metal according to the present invention have been detailed so far. However, the present copper brazing filler metal is not limited to the above-described embodiment modes. Hence, it is possible to complete the present copper brazing filler metal in various modes, to which changes or modifications that one of ordinary skill in the art can carry out are made, within a range not departing from the spirit or scope of the present invention.

### EXAMPLES

Hereinafter, the copper brazing filler metal according to the present invention will be described in more detail while giving specific examples.

### Making of Copper Brazing-Filler Metals (No. 1)

A procedure as described below was followed to make Cu—Ni—Mn—Si—B copper brazing-filler metals or Cu—Ni—Mn—Si—B—Fe copper brazing-filler metals that had compositions being listed in Table 1. Table 1 also gives the calculated values of {(Ni Content)+(Fe Content)}/(Mn Content). Note that, although the calculated values being listed in Table 1 were rather the values of (Ni Content)/(Mn Content) exactly when the copper brazing-filler metals were free from Fe, both values will be hereinafter referred to as the values of {(Ni Content) (Fe Content)}/(Mn Content) for convenience.

First of all, metallic powders including the respective elements were weighed out by the prescribed amounts. Note that the metallic powders had a particle diameter of 145 μm or less. Then, those weighed metallic powders were subjected to a mixing treatment in which they were rotated after be ing put in a container, thereby producing a mixed powder. The resulting mixed powder was filled up in a die in order to form a cylindrical green compact formed body by pressure forming. Note that the resultant cylindrical green compact formed body had a diameter of φ 20 mm and a length of from 10 to 15 mm.

The thus obtained green compact was melted with use of an Ar-gas-plasma button melting furnace, or by Ar-gas-plasma button melting, thereby making a copper brazing-filler alloy ingot in an amount of from 20 to 30 g. The “Ar-gas-plasma button melting” is a method in which Ar-gas plasmas are generated in order to melt various metallic materials in argon-gas atmospheres, thereby producing button-shaped ingots. A water-cooled crucible being made of copper was put in place within a chamber of the Ar-gas-plasma button melting furnace. Then, the green compact was held inside the cuprous crucible. Subsequently, an Ar gas was introduced into the chamber after pumping the inside of the chamber down to a vacuum. Thus, the Ar gas substituted for the atmosphere within the chamber. Thereafter, Ar-gas plasmas were generated inside the chamber in order to melt the green compact. After stopping generating the Ar-gas plasmas, a fused or molten raw-material, which had been obtained by melting the green compact inside the crucible, was solidified within the crucible, thereby producing an ingot.

Moreover, the resulting ingot was inverted upside down. Then, the same procedure was followed in order to re-melt and re-solidify the ingot. In addition, this operation was furthermore carried out twice repeatedly, thereby producing a button-shaped copper brazing-filler metal ingot.

Note that the resulting copper brazing-filler metal ingot was cut to given dimensions to use for the making of joined bodies that will be described hereinafter.

### Making of Joined Bodies (No. 1)

Two green compacts were sintered and brazed together simultaneously, thereby making a joined body comprising sintered bodies. Hereinafter, a procedure for making the joined body will be described.

First of all, various green compacts were made. Note that the green compacts had the same overall composition with each other but had different dimensions and densities one another. For example, the green compacts comprised Cu in an amount of 2% by mass, C in an amount of 0.8% by mass, and the balance being Fe essentially, when the entirety is taken as 100% by mass. The following were then made ready for raw-material powders: a pure iron powder; an Fe-10% Cu alloy powder including Cu in an amount of 10% by mass; and a graphite powder. Note that the three raw-material powders had a particle diameter of 145 μm or less. The respective raw-material powders were weighed out by predetermined amounts. Then, the weighed raw-materials were subjected to a rotary mixing treatment inside a container for 30 minutes, thereby producing a mixed powder.

The resulting mixed powder was formed by a die-wall lubrication warm pressure compaction method using a die, thereby producing the following two green compacts: a first green compact having a diameter of φ 20 mm and a length of 5 mm; and a second green compact having a diameter of φ 12.7 mm and a length of 10 mm. Moreover, the forming pressure during forming was changed in order to control the density of the first and second green compacts so as to be 6.8 g/cm³ and 7.0 g/cm³, respectively. Note that the densities can be converted into the density ratios of 87.2% and 89.7%, respectively.

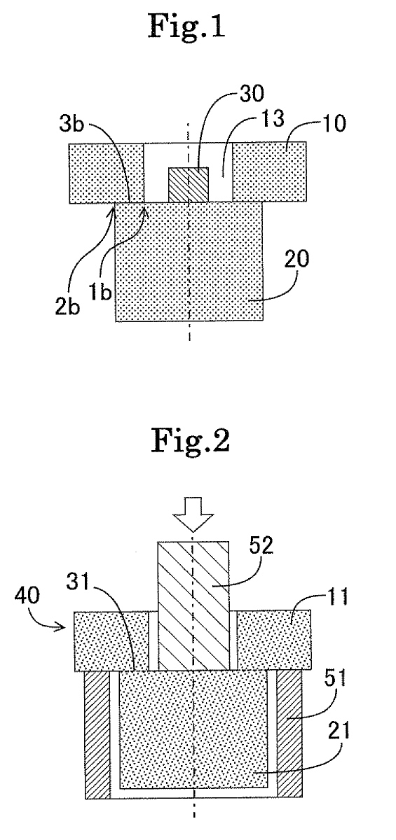

Two of the green compacts with an identical density but with different dimensions were sintered and brazed together simultaneously, thereby making joined bodies for evaluating the strength at the joint. A procedure for ma king the joined bodies will be described with reference to FIG. 1. To begin with, one of the first green compacts were bored by drilling at the central part in order to process a through hole 13 with φ 8.5 mm that was coaxial with the first green compact. Thus, the first green compacts were made into a green compact 10 having a cylindrical or annular configuration, respectively. Then, one of the green compacts 10 was placed coaxially on one of the second green compacts, that is, on one of green compacts 20 with the same density as that of the green compact 10, as shown in FIG. 1. Likewise, the other one of the green compacts 10 was placed on the other one of green compacts 20 coaxially, as shown in the drawing. After weighing out a brazing filler metal 30 by prescribed amounts, the weighed brazing filler metals 30 were placed on the green compacts 20 so that they were positioned at around the central part of the through hole 13, respectively. Note that Table 1 below lists the amounts of the employed brazing filler metals that are represented by masses of the brazing filler metals per an area of the end face of the green compact 20. The resulting sub-assemblies of the green compact 10, green compact 20 and brazing filler metal 30 were subjected to a calcining treatment at 1,150° C. for 15 minutes in a nitrogen-gas atmosphere. Thus, the green compact 10 and green compact 20 were sintered and brazed together simultaneously. Note that a flow volume of N₂, the nitrogen gas, was controlled at 2.0 L/minute.

When being sintered, the brazing filler metal 30 fused or melted to flow on the top end face of the green compact 20 on which the brazing filler metal 30 was placed. After having reached the inner peripheral corner 1b of the green compact 10, the brazing filler metal 30 flowed into the joining face 3b, and then reached the outer peripheral corner 2b of the green compact 20, thereby completing the joining between the green compact 10 and the green compact 20. While the brazing filler metal 30 thus flowed, the sintering of the green compact 10 and green compact 20 developed as well. Thus, a sintered and joined body was produced.

Note that a sintered body being labeled “SB1” and another sintered body being labeled “SB2” were made as reference examples in the following manner. The same mixed powder as described above was used to form cylinder-shaped green compacts having a diameter of φ 20 mm and a length of 14 mm. Thereafter, the resulting cylinder-shaped green compacts were sintered under the same conditions as described above. Then, the resultant sintered bodies were cut to the same dimensions and shape as those of the above-described sintered and joined body. Moreover, instead of the green compact 10 and green compact 20, two melt-produced stocks, which had the same dimensions and shape as those of the green compact 10 and green compact 20, were prepared from a carbon steel for mechanical structure (e.g., S45C as per Japanese Industrial Standard). Then, the same procedure as described above was followed using the resulting melt-produced stocks, thereby making joined bodies being labeled “#29” and “#33.”

### Evaluations (No. 1)

### Joint Strength

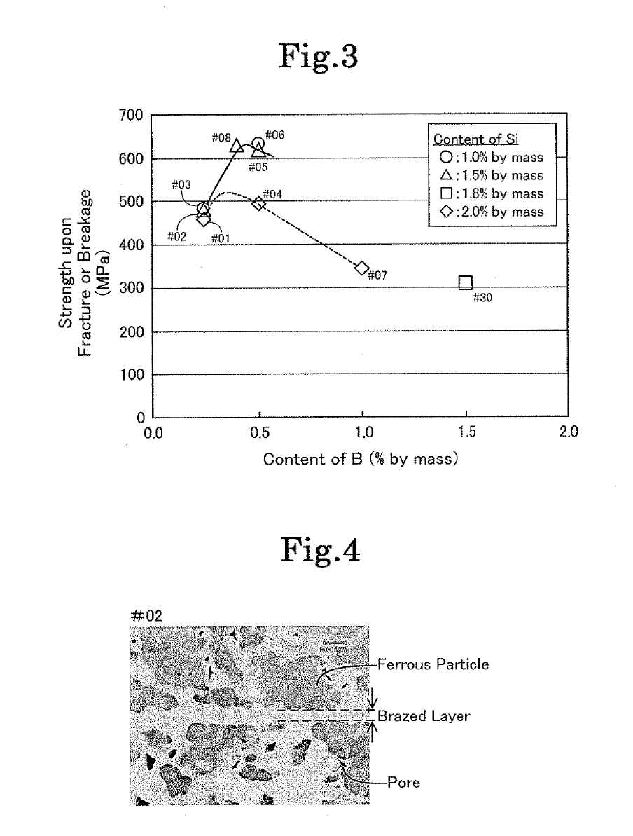

The joint strength of the joined bodies was evaluated by measuring their strengths upon fracture or breakage by a method illustrated in FIG. 2. Note that a joined body 40 comprised a cylindrical tubular section 11, which was made by sintering the green compact 10, and a cylindrical columnar section 21, which was made by sintering the green compact 20, as shown in the drawing. The joined body 40 was placed on the top end face of a cylinder-shaped supporting stand 51 so that the cylindrical columnar section 21 was accommodated coaxially within the hollow tubular section of the supporting stand 51. Note that the supporting stand 51 had an outside diameter φ 22 mm, an inside diameter φ 14 mm, and a length 25 mm. Then, a punch 52 with φ 6 mm in outside diameter was inserted into the through hole of the cylindrical tubular section 11. Subsequently, an increasing load was applied to the cylindrical columnar section 21 via the punch 52 in order to separate the cylindrical columnar section 21 from the cylindrical tubular section 11 (or to fracture or break the joined body 40). A maximum load required for fracturing or breaking the joint body 40 was measured in order to calculate the strength upon fracture or breakage. The strength upon fracture or breakage is a value that is obtained by dividing a maximum load upon fracture or breakage with an area of joint face. That is, the strength upon fracture or breakage can be determined by the following equation: (Strength upon Fracture or Breakage (MPa))=(Maximum Load upon Fracture or Breakage (N))/(Area of Joint Face (mm²)). The thus determined strengths upon fracture or breakage are listed in Table 1, and are also illustrated in FIG. 3. Note that Table 1 gives average values of the strengths upon fracture or breakage (or averaged strengths upon fracture or breakage) that were obtained by examining four pieces of the joined bodies 40, which had been made under the same conditions, for the strength upon fracture or breakage, respectively, as described above. Moreover, a fluctuation band was found from the four values of the resultant strengths upon fracture or breakage. That is, the fluctuation band can be found by the following equation: (Fluctuation Band (%))={(Maximum Strength upon Fracture or Breakage (N))−(Minimum Strength upon Fracture or Breakage (N))}/(Averaged Strength upon Fracture or Breakage (N))×100, for instance. Results of the thus found fluctuation bands are also listed in Table 1.

TABLE 1

| | | | Density | Supply Amount | Strength upon | |
|---|---|---|---|---|---|---|
| No. of | | | of Green | of Brazing | Fracture or | |
| Joined | Composition of Brazing Filler Metal | | Compact | Filler Metal | Breakage | Fluctuation |
| Body | Composition (% by mass) | (Ni + FE)/Mn | (g/cm³) | (g/cm²) | (MPa) | Band (%) |
| #01 | Cu—30Ni—25Mn—2.0Si—0.25B | 1.20 | 7.0 | 0.24 | 458 | 31 |
| #02 | Cu—30Ni—25Mn—1.5Si—0.25B | 1.20 | 7.0 | 0.24 | 485 | 32 |
| #03 | Cu—30Ni—25Mn—1.0Si—0.25B | 1.20 | 7.0 | 0.24 | 482 | 19 |
| #04 | Cu—30Ni—25Mn—2.0Si—0.5B | 1.20 | 7.0 | 0.24 | 496 | 70 |
| #05 | Cu—30Ni—25Mn—1.5Si—0.5B | 1.20 | 7.0 | 0.24 | 615 | 27 |
| #06 | Cu—30Ni—25Mn—1.0Si—0.5B | 1.20 | 7.0 | 0.24 | 631 | 17 |
| #07 | Cu—30Ni—25Mn—2.0Si—1.0B | 1.20 | 7.0 | 0.24 | 346 | 59 |
| #08 | Cu—30Ni—25Mn—1.5Si—0.4B | 1.20 | 7.0 | 0.24 | 634 | 24 |
| #09 | Cu—30Ni—25Mn—1.5Si—0.4B | 1.20 | 6.8 | 0.24 | 445 | 31 |
| #10 | Cu—30Ni—25Mn—1.5Si—0.4B—5Fe | 1.40 | 6.8 | 0.24 | 494 | 31 |
| #11 | Cu—30Ni—25Mn—1.5Si—0.4B—10Fe | 1.60 | 6.8 | 0.24 | 550 | 20 |
| #12 | Cu—30Ni—25Mn—1.5Si—0.25B—10Fe | 1.60 | 6.8 | 0.24 | 444 | 28 |
| #13 | Cu—28Ni—27Mn—1.5Si—0.4B | 1.04 | 6.8 | 0.24 | 279 | 76 |
| #14 | Cu—28Ni—27Mn—1.5Si—0.4B—2.5Fe | 1.13 | 6.8 | 0.24 | 485 | 18 |
| #15 | Cu—28Ni—27Mn—1.5Si—0.4B—5Fe | 1.22 | 6.8 | 0.24 | 494 | 24 |
| #16 | Cu—28Ni—27Mn—1.5Si—0.4B—10Fe | 1.41 | 6.8 | 0.24 | 533 | 32 |
| #17 | Cu—28Ni—27Mn—1.5Si—0.4B—15Fe | 1.59 | 6.8 | 0.24 | 430 | 44 |
| #18 | Cu—25Ni—27Mn—1.5Si—0.4B | 0.93 | 6.8 | 0.24 | 247 | 41 |
| #19 | Cu—25Ni—27Mn—1.5Si—0.4B—5Fe | 1.11 | 6.8 | 0.24 | 467 | 24 |
| #20 | Cu—25Ni—27Mn—1.5Si—0.4B—10Fe | 1.30 | 6.8 | 0.24 | 528 | 18 |
| #21 | Cu—25Ni—27Mn—1.5Si—0.4B—15Fe | 1.48 | 6.8 | 0.24 | 592 | 19 |
| #22 | Cu—30Ni—20Mn—1.5Si—0.4B—5Fe | 1.75 | 6.8 | 0.24 | 467 | 24 |
| #23 | Cu—30Ni—25Mn—1.5Si—0.4B | 1.20 | 7.0 | 0.16 | 502 | 23 |
| #24 | Cu—30Ni—25Mn—1.5Si—0.4B—5Fe | 1.40 | 7.0 | 0.16 | 515 | 13 |
| #25 | Cu—30Ni—25Mn—1.5Si—0.4B—10Fe | 1.60 | 7.0 | 0.16 | 579 | 12 |
| #26 | Cu—28Ni—27Mn—1.5Si—0.4B | 1.04 | 7.0 | 0.16 | 470 | 50 |
| #27 | Cu—28Ni—27Mn—1.5Si—0.4B—2.5Fe | 1.13 | 7.0 | 0.16 | 563 | 14 |
| #28 | Cu—28Ni—27Mn—1.5Si—0.4B—5Fe | 1.22 | 7.0 | 0.16 | 521 | 25 |
| #29 | Cu—30Ni—25Mn—1.5Si—0.4B | 1.20 | (7.8) * | 0.05 | 607 | 7 |
| #30 | Cu—41.2Ni—15.5Mn—1.8Si—1.5B | 2.66 | 7.0 | 0.24 | 306 | 81 |
| #31 | Cu—41.2Ni—15.5Mn—1.8Si—1.5B | 2.66 | 6.8 | 0.24 | 322 | 73 |
| #32 | (Cu—41.2Ni—15.5Mn—1.8Si—1.5B) + | 3.37 | 6.8 | 0.24 | 356 | 60 |
| | 10Fe | | | | | |
| #33 | Cu—41.2Ni—15.5Mn—1.8Si—1.5B | 2.66 | (7.8) * | 0.06 | 492 | 7 |
| — | Sintered Body “SB1” | — | 7.0 | — | 490 | 5 |
| — | Sintered Body “SB2” | — | 6.8 | — | 429 | 2 |

Note:
the mark “*” indicates the density of melt-produced stock.

The joined bodies #02, #08, and #30 were observed at the joint, respectively, by an optical microscope. In the optical microscopical observation, each of the joint bodies being made as described above was cut in the axial direction perpendicularly to the diameter of the opposite end faces. The resulting cut face was observed using an optical microscope. FIGS. 4 through 6 illustrate results of the observations.

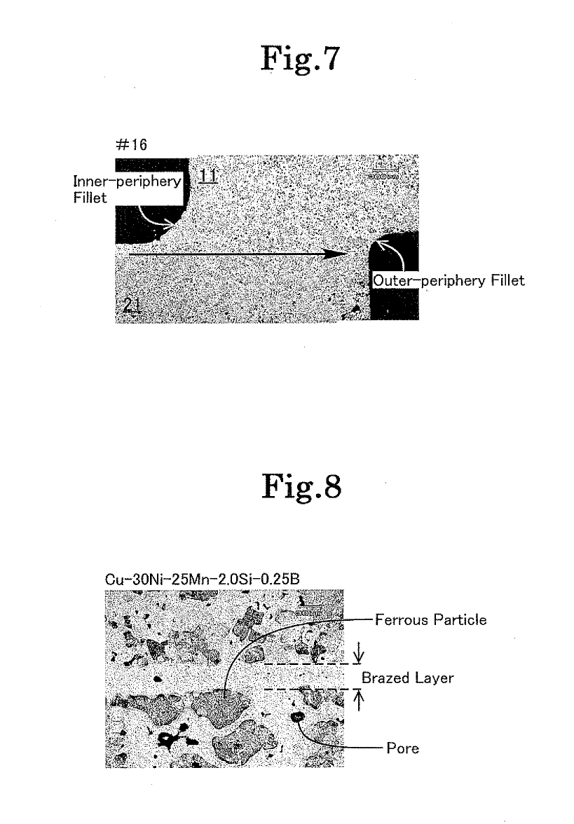

Note that FIG. 7 illustrates results of an observation that was carried out onto the joint of the joined body #16 by the same method as described above. It was ascertained from FIG. 7 how the brazed layer was formed, that is, a fused or molten brazing filler metal flowed to form the brazed layer as follows: the molten brazing filler metal flowed on the top end face of the second green compact (i.e., the sintered body 21 in FIG. 2) on which the brazing filler metal was placed; the molten brazing filler metal reached the inner peripheral corner 1b of the first green compact (i.e., the sintered body 11 in the drawing); thereafter the brazing filler metal flowed between the joining faces; and then the brazing filler metal reached the outer peripheral corner 2b of the second green compact (i.e., the sintered body 21 in the drawing) to complete the brazed layer. Moreover, the molten brazing filler metal flowed in such a direction that the bold arrow-headed line represents in FIG. 7.

### Elemental Analysis on Brazed Fillets

An elemental analysis was carried out onto the resulting brazed fillets with use of an electron-beam prove microanalyzer (or EPMA). The elemental analysis was performed onto two locations in the joined bodies #08 and #30, that is, the inner periphery 1b (i.e., the inner peripheral fillet) and the outer periphery 2b (i.e., the outer peripheral fillet) in the joined bodies. FIG. 7 shows the analyzed locations specifically. Table 2 summarizes results of the elemental analyses.

TABLE 2

| No. of | | | | | | | | | | |
|---|---|---|---|---|---|---|---|---|---|---|
| Joined | Composition of Brazing Filler Metal | | Analyzed | Analyzed Value (% by mass) | | | | | | |
| Body | Composition (% by mass) | (Ni + Fe)/Mn | Position | Fe | Ni | Mn | Si | B | C | Cu |
| #08 | Cu—30Ni—25Mn—1.5Si—0.4B | 1.20 | Inner | 16.1 | 22.2 | 20.1 | 1.2 | — | 0.5 | Balance |
| | | | Periphery | | | | | | | |
| | | | Outer | 19.0 | 23.0 | 19.8 | 1.3 | — | 0.5 | Balance |
| | | | Periphery | | | | | | | |
| #30 | Cu—41.2Ni—15.5Mn—1.8Si—1.5B | 2.66 | Inner | 30.7 | 30.1 | 10.5 | 1.4 | — | 0.5 | Balance |
| | | | Periphery | | | | | | | |
| | | | Outer | 40.6 | 30.2 | 9.3 | 1.5 | — | 0.5 | Balance |
| | | | Periphery | | | | | | | |

FIG. 3 illustrates the strengths upon fracture or breakage that the joined bodies #01 through #08 and #30 exhibited. When the B content in the employed brazing filler metals fell in a range of from 0.25 to 0.5%, the resulting joined bodies showed higher strengths upon fracture or breakage that were more than 400 MPa. In particular, when the B content fell in a range of from 0.4 to 0.5% approximately, it was found that the joined bodies exhibited strengths upon fracture or breakage that exceeded 490 MPa that the sintered body “SB1” having an identical density exhibited upon fracture or breakage. Therefore, it was understood that reducing the B content to 0.5% or less is effective for highly strengthening the resultant joined bodies against fracture or breakage. Moreover, the less the Si content was the higher the resulting joined bodies exhibited the joint strength. For example, the joined bodies #02, #03, #05, #06 and #08 whose Si content was 1.5% or less fractured or broke on the side of the sintered bodies, that is, at the major section of the joined bodies other than the joint faces. As shown in Table 1, the fluctuation band of the strengths upon fracture or breakage became smaller when the Si content was 1.5% or less in the brazing filler metals. In other words, it became apparent that it is effective to reduce the Si content in order to highly strengthen the resultant joined bodies and securely provide the joints with reliable qualities.

From the above-described results, it is evident that brazing filler metals whose B and Si contents are reduced are effective for strengthening the resulting joined bodies highly and upgrading the joints in qualities, and that it is valid to add B and Si compositely. Although Table 1 does not give any brazing filler metals to which no B was added, such as a Cu-30Ni-25Mn-1.5Si brazing filler metal, for instance, it was not possible for such boron-free brazing filler metals to unite the above-described first and second green compacts together.

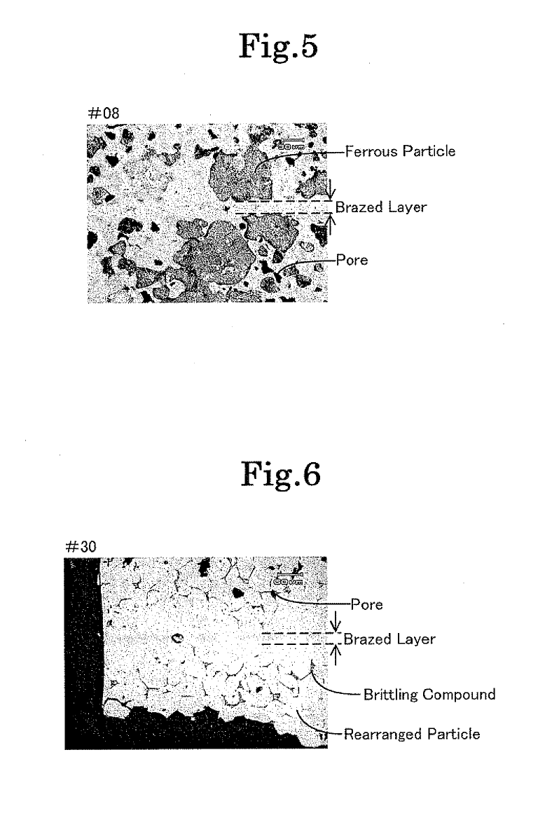

Moreover, FIG. 4 shows the joint in the joined body #02 that was made using the brazing filler metal whose B content was 0.25%. Since the B content in the brazing filler metal was less, brittling compounds like Fe₂B hardly appeared. In addition, FIG. 5 shows the joint in the joined body #08 that was made using the brazing filler metal whose B content was 0.4%. As can be seen from FIG. 5, it was observed that brittling compounds dispersed not only in the brazed layer but also in the brazing filler metal that solidified within the pores, because the brazing filler metal for making the joined body #08 contained B in a greater amount than did the brazing filler metal for making the joined body #02 shown in FIG. 4. In FIGS. 4 and 5, it is possible to observe the ferrous particles making the sintered bodies clearly, because it is possible to see that the brazing filler metals, which went into the pores in the sintered bodies, were alloyed with the ferrous particles and were then united firmly with the surface of the ferrous particles. On the contrary, FIG. 6 shows the joint in the joined body #30 that was made using the brazing filler metal whose B content was 1.5%. In FIG. 6, however, it is not possible to observe the ferrous particles making the sintered bodies clearly, but it is possible to see only a metallic structure in which the structures of sintering materials disappeared because the rearrangement of particles that is specific to liquid-phase sintering occurred. Besides, it was observed that coarse Fe₂B and its eutectic structures were formed in a large amount at the grain boundaries between the rearranged particles and at the triple points between them. Moreover, it was possible to ascertain that the fracture or breakage of the joints developed along these parts in which brittling compounds are formed. It became apparent from the above-described results that using brazing filler metals comprising B and Si in reduced amounts is effective for improving structures in the resulting joints and eventually upgrading the strength of the joints against fracture or breakage.

In addition, according to the elemental analysis on the brazed fillets in the joined bodies #08 and #30, it was found that Fe was dissolved from the green compacts into the resulting brazed fillets in both of the two joined bodies, and that the Fe content increased more on the outer peripheral side, which was away from the brazing-filler supplying position, than on the inner peripheral side, which was near the brazing-filler supplying position. The joined bodies #30 comprised Fe in a larger amount of from 30 to 40%, and the difference was greater between the Fe content in the inner peripheral side and the Fe content in the outer peripheral side. Therefore, it was assumed that the composition fluctuated greatly depending on the positions of the resultant joint. On the contrary, the joined body #08 comprised Fe in a smaller amount of 19%, about a half of the Fe content in the joined body #30, even on the outer peripheral side, and the difference was smaller between the Fe content in the inner peripheral side and the Fe content in the outer peripheral side. Accordingly, it is believed that the joined body #08 accomplishes uniform or homogenous unification in which the composition fluctuates less, regardless of the positions of the resulting joint. Since (Fe, Mn, Ni)₂B made the compositions of not-shown crystallized phases that were observed at the fillets, it is assumed that B in the brazing filler metals is consumed to generate the intermetallic compounds. Consequently, in the joined body #08 comprising B in a smaller amount than did the joined body #30, it is possible to say that the brittling compounds are generated in a reduced amount, and that the reactions of the brazing filler metal with the ferrous powders making the green compacts are inhibited from fusing or melting the resultant sintered bodies.

The joined bodies #09 through #22 were joined bodies that were made using the green compacts whose density was 6.8 g/cm³ that was smaller than that of the green compacts for making the joined bodies #01 through #08. Note that the supplying amount of the brazing filler metals was controlled so as to be identical one another in making the joined bodies #01 through #22. Moreover, the brazing filler metal having an equal composition to each other was employed to make the joined bodies #08 and #09. When comparing the two with each other, the joined bodies #09, which were made using the green compacts whose density was lower, exhibited a lower strength upon fracture or breakage than did the joined bodies #08, which were made using the green compacts whose density was higher. However, the brazing filler metals having compositions that fell within the above-described enough ranges were employed in order to make the joined bodies #09 through #12, #14 through #17 and #19 through #22, and thereby the resulting joined bodies exhibited strengths upon fracture or breakage that were more than 429 MPa exhibited by the sintered body “SB2,” which had the same density as those of the green compacts, upon fracture or breakage.

The joined bodies #09 through #11, #13 through #17 and #18 through #21 were joined bodies that were made using the Cu—Ni—Mn—Si—B brazing filler metals whose Fe contents were distinct to each other. When the Fe content increased and accordingly the {(Ni Content) (Fe Content)}/(Mn Content) value increased, the joined bodies exhibited increasing strengths upon fracture or breakage, and the fluctuation bands tended to decline. However, it was found that, when the brazing metals comprise Fe in an excessive amount, the resulting brazing filler metal might lead to lowering the strength upon fracture or breakage, like the joined body #17 did, depending on the brazing filler metal's composition. It is believed that the decline results from that the molten separation of brazing metal has occurred to change the flowability.

Moreover, the joined bodies #11 and #12 were joined bodies that were made using the Cu—Ni—Mn—Si—B brazing filler metals that contained Fe in an equal amount to each other but contained B in distinct amounts to each other. The two exhibited higher strengths upon fracture or breakage because they comprised B in restrained amounts, and the resulting strengths upon fracture or breakage were more than that of the sintered body “SB2.” However, when the brazing filler metal whose B content was 0.25% was used to make the joined body #12, the resultant joined bodies exhibited smaller strengths upon fracture or breakage than did the joined bodies according to the joined body #11, and the resulting fluctuation band was greater.

The joined body #22 was made using the Cu—Ni—Mn—Si—B—Fe brazing filler metal whose Mn content was reduced to 20%. The joined body #22 exhibited a higher strength upon fracture or breakage than did the sintered body “SB2” having an identical density.

Note that FIG. 7 also shows results of observations on the joint in the joined body #16. In the joined body #16, the brazing filler metal infiltrated shallowly in the depth-wise direction, and the joint was unified favorably, as can be seen from the photograph.

Each of the joined bodies #23 through #25 and #26 through #28 was made by brazing the green compacts having a density of 7.0 g/cm³ with use of the same brazing filler metals as those employed to make each of the joined bodies #09 through #11 and #13 through #15. Note that, although the joined bodies #08 and #23 were made by brazing the like two green compacts having the aforementioned same density with use of the same brazing filler metal, they exhibited different strengths upon fracture or breakage. The difference between the strengths is believed to result from the supply amounts of the brazing metal that differed with each other. Even when the supply amount of the brazing filler metal was reduced to make the joined body #23, the resulting joined bodies exhibited higher strengths upon fracture or breakage than did the sintered body “SB1,” and the resulting fluctuation band was smaller. Thus, the joined body 23 was found to have stable qualities at the joint. Each of the joined bodies #23 through #28 also exhibited a high strength upon fracture or breakage that was more than 400 MPa. However, the brazing filler metal used to make the joined body #26 did not result in a high joint strength when the two green compacts having a density of 6.8 g/cm³ were united together to make the joined body #13. That is, it is possible to say that the brazing filler metal used to make the joined bodies #13 and #26 are likely to result in fluctuating joint densities that depend on the densities of green compacts to be united. Note that the brazing filler metals that led to producing such green compacts with fluctuating densities had compositions whose {(Ni Content)+(Fe Content)}/(Mn Content) values were less than 1.1.

### Making of Sheet-shaped Copper Brazing Filler Metal (No. 2)

Powdered raw materials were used to make a sheet-shaped copper brazing filler metal. The resulting sheet-shaped copper brazing filler metal comprised a Cu-30Ni-25Mn-2.0Si-0.25B copper alloy. Hereinafter, a procedure for making the alloy will be described.

First of all, metallic powders that contained each of the respective constituent elements were weighed out by predetermined amounts, and were compounded to make a mixed powder having a preliminary targeted composition from which Cu was excluded. The resulting mixed powder was fused to melt produce an Ni—Mn—Si—B alloy. Since the resultant Ni—Mn—Si—B alloy was readily crushable, it was pulverized until it turned into a powder having a particle diameter of 145 μm or less. A Cu powder having a particle diameter of 75 μm or less was prepared in such an amount that the resulting mixed powder made the above-described complete or final targeted composition as a whole, and was then added to and mixed with the Ni—Mn—Si—B alloy powder prepared as above. The resultant mixed powder was press formed, thereby making a green compact formed body whose width was 10 mm, length was 55 mm and thickness was 2 mm. The resulting green compact was pre-sintered by heating it at 700° C. for 15 minutes in a nitrogen-gas atmosphere (e.g., in a flow of N₂ in a controlled flow volume of 2.0 L/minute).

The pre-sintered green compact formed body was subjected to cold rolling. The 2-mm thickness green compact formed body was press rolled down to a 0.1-mm thickness one by the processing. The cold-rolled 0.1-mm thickness green compact formed body was sintered fully or completely by heating it at 850° C. for 20 minutes in a nitrogen-gas atmosphere (e.g., in a flow of N₂ in a controlled flow volume of 2.0 L/minute).

### Making of Joined Body Using Sheet-shaped Copper Brazing Filler Metal (No. 2)

The sheet-shaped copper brazing filler metal being made in accordance with the above-described procedure was used to sinter and simultaneously braze two green compacts together, thereby making a joined body comprising sintered members. The above-described two second cylindrical green compacts whose density was 7.0 g/cm³ were prepared for the green compacts to be joined together. The following procedure was followed in order to braze the two green compacts together coaxially.

The sheet-shaped copper brazing filler metal was cut to a disk that had the same dimension diametrically as that of the resulting joint faces. The resulting circular sheet-shaped copper brazing filler metal was held between the two green compacts in order to sinter and braze the green compacts together under the above circumstances. The sintering and brazing were carried out at 1,150° C. for 15 minutes in a nitrogen-gas atmosphere (e.g., in a flow of N₂ in a controlled flow volume of 2.0 L/minute).

FIG. 8 shows a cross section of the joint in the joined body that was made using the sheet-shaped Cu-30Ni-25Mn-2.0Si-0.25B brazing filler metal. As shown in the photograph, the brazing filler metal, which went into the pores in the sintered bodies, was alloyed with the ferrous particles and were then united firmly with the surface of the ferrous particles. As a result, the ferrous particles making the sintered bodies could be observed clearly as shown in FIG. 8. It is assumed from the photograph that the joined body exhibits high strengths at the joint that fluctuate less.

### Making of Copper Brazing Filler Metal (No. 3)

Joined bodies being labeled #34 through #36 were made using Cu—Ni—Mn—Si—B—Fe brazing metals that had compositions shown in Table 3 below. The joined bodies #35 and #36 were made using two button-shaped Cu—Ni—Mn—Si—B—Fe brazing metals that were made by the same method as described in above (Making of Copper Brazing Filler Metal (No. 1)). Note that the joined body #34 was made employing a brazing filler metal that was formed as a rod stock by subjecting the resulting ingot to working processes in the procedure described below.

That is, lump metals containing the respective constituent elements and an Fe—B master alloy were weighed out in a summed amount of 1 kg, and were then dissolved by high-frequency dissolution, one of common dissolving processes. Thus, a rod-shaped metal ingot was prepared. The resulting alloy ingot had a diameter of φ 20 mm and a length of 200 mm. The rod-shaped metal ingot was drawn to φ 5 mm by subjecting it to hot swaging at 820° C. After cooling the resulting drawn product gradually, it was further subjected to cold swaging, which was carried out at room temperature (i.e., 25° C.), thereby preparing a rod stock having a diameter of φ 3.5 mm.

### Making of Joined Bodies (No. 3)

Of the above-described green compacts, two of the powder contacts whose density was 6.8 g/cm³ were sintered and brazed together simultaneously in order to make sintered joined bodies being labeled #34 through #36. Except that the brazing-filler-metal supply amount was set at 0.31 g/cm³, the joined bodies #34 through #36 were produced by the same making procedure and under the same making conditions as described in (Making of Joined Body Using Copper Brazing Filler Metal (No. 1)). However, note that the joined body #34 was made with use of the rod-stock brazing filler metal having φ 5 mm that had not been subjected to the above-described cold swaging, which was weighed out by a predetermined amount after being cut to a length of 2.5 mm, and whose cut pieces were then placed diametrically horizontally at the middle in the through hole 13 of the green compact 10.

### Evaluations (No. 3)

The joined bodies #34 through #36 were examined for the strengths upon fracture or breakage and fluctuation bands. Table 3 below gives the results.

TABLE 3

| | | | Density | Supply Amount | Strength upon | |
|---|---|---|---|---|---|---|
| No. of | | | of Green | of Brazing | Fracture or | |
| Joined | Composition of Brazing Filler Metal | | Compact | Filler Metal | Breakage | Fluctuation |
| Body | Composition (% by mass) | (Ni + Fe)/Mn | (g/cm³) | (g/cm²) | (MPa) | Band (%) |
| #34 | Cu—30Ni—20Mn—1.5Si—0.4B—7Fe | 1.85 | 6.8 | 0.31 | 527 | 14 |
| #35 | Cu—35Ni—20Mn—1.5Si—0.4B—12Fe | 2.35 | 6.8 | 0.31 | 574 | 15 |
| #36 | Cu—35Ni—20Mn—1.5Si—0.4B—17Fe | 2.60 | 6.8 | 0.31 | 127 | 27 |

The joined bodies #34 and #35 made joined bodies exhibiting higher strength at the joint, because they exhibited a better strength upon fracture or breakage and a lower fluctuation band, respectively, as shown in Table 3 above.

The brazing filler metal used to make the joined body #34 contained Fe greater than did the brazing filler metal used to make the joined body #22 given in Table 1. Although brazing-filler-metal supply amount differed in making the two joined bodies, that is, it was more in making the former than in making the latter, the joined body #34 was superior to the joined body #22 in terms of the characteristics. The advantage is assumed to result from adding Fe in a greater amount.

The joined body #35 was made with use of the brazing metal whose summed content of the Ni and Fe contents (i.e., (Ni Content)+(Fe Content)) was increased more than that of the brazing alloy used to make the joined body #34. According to Table 3, it is seen that, even when the value of {(Ni Content)+(Fe Content)}/(Mn Content) exceeded 2, such a low brazing-filler-metal supply amount as 0.31 g/cm² could lead to keeping strength high at the joint. In other words, it is understood that setting the value of {(Ni content)+(Fe content)}/(Mn content) to 2.5 or less enables the resulting joined bodies to exhibit a desirable strength at the joint, respectively.

Since the brazing metal used to make the joined body #36 contained Fe too much, it did not produce any desirable strength at the joint even when the brazing operation was carried out by supplying the brazing filler metal in an increased brazing-filler-metal supply amount that was greater than those in making the joined bodies shown in Table 1. Thus, it was appreciated that keeping the Fe content down to 16% or less is required in order to obtain strength at the joint satisfactorily or adequately.

Having now fully described the present invention, it will be apparent to one of ordinary skill in the art that many changes and modifications can be made thereto without departing from the spirit or scope of the present invention as set forth herein including the appended claims.

What is claimed is:

1. A copper brazing filler metal for joining sintered structural component parts having a joint between at least two joined workpieces being made of a ferrous material, at least one of the two joined workpieces comprising a sintered body, the copper brazing filler metal comprising:
nickel (Ni) in an amount of from 20 or more to 36% or less by mass (hereinafter being simply referred to as “%”);
manganese (Mn) in an amount from 19 or more to 30% or less;
iron (Fe) in an amount of from 0 or more to 16% or less;
silicon (Si) in an amount of from more than 0 to 2% or less;
boron (B) in an amount of from 0.1 or more to 0.5% or less; and
the balance being copper (Cu) as well as inevitable impurities and/or a modifying element;
when the entirety is taken as 100%; and
the copper brazing filler metal exhibiting a ratio of the Ni content with respect to the Mn content (i.e., (Ni Content)/(Mn Content)) that falls in a range of from 1.1 or more to 2 or less when being free from Fe.

2. The copper brazing filler metal according to claim 1, wherein a sum of the B amount and the Si amount is 2.3% or less.

3. The copper brazing filler metal according to claim 1, wherein the B amount falls in a range of from 0.2 or more to 0.5% or less.

4. The copper brazing filler metal according to claim 1, wherein the Si amount falls in a range of from 0.1 or more to 1.8% or less.

5. The copper brazing filler metal according to claim 1, wherein the ratio, (Ni Content)/(Mn Content), falls in a range of from 1.15 or more to 1.9 or less.

6. The copper brazing filler metal exhibiting a second ratio of a summed content of the Ni content and Fe content with respect to the Mn content (i.e., {(Ni Content)+(Fe Content)}/(Mn Content)) that falls in a range of from 1.1 or more to 2.5 or less when further including Fe.

7. The copper brazing filler metal according to claim 6, wherein the second ratio, {(Ni Content)+(Fe Content)}/(Mn Content), falls in a range of from 1.15 or more to 2.4 or less.

8. The copper brazing filler metal according to claim 1 comprising a green compact being made by forming a mixed powder that is made by mixing an Ni—Mn—Si—B alloy powder, which comprises an alloy including Ni, Mn, Si and B at least, with a copper powder, which includes copper, in proportions that are in compliance with a targeted composition.

9. The copper brazing filler metal according to claim 8 being made by further sintering the green compact and then plastically processing it into a predetermined configuration.

10. The copper brazing filler metal according to claim 9 being made by plastically processing the sintered green compact into a thin plate or sheet, or a wire or rod stock.

11. The copper brazing filler metal according to claim 8, wherein the Ni—Mn—Si—B alloy further includes Fe.

12. The copper brazing filler metal according to claim 8, wherein the mixed powder includes the Ni—Mn—S—B alloy powder and the copper powder as well as an iron powder including Fe.

13. A copper brazing filler metal comprising a copper alloy that has a composition according to claim 1.

14. The copper brazing filler metal according to claim 13, wherein the copper alloy has an ingot shape, or a powdery shape.

15. The copper brazing filler metal according to claim 13 being made into a thin plate or sheet, or a wire or rod stock, by plastically processing an ingot that comprises the copper alloy.

16. The copper brazing filler metal according to claim 1 exhibiting a melting point that falls in a range of from 970 to 1,100° C. approximately.
